(19) United States
(12) Patent Application Publication
(10) Pub. No.: US 2010/0050035 A1
(43) Pub. Date: Feb. 25, 2010

(54) METHOD FOR PREVENTING CONSECUTIVE PACKET ERRORS IN SELECTIVE HYBRID ARQ SYSTEM

(75) Inventors: Tae-Chul Hong, Daejon (KR); Kun-Seok Kang, Daejon (KR); Do-Seob Ahn, Daejon (KR); Ho-Jin Lee, Daejon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/441,277

(22) PCT Filed: Sep. 13, 2007
(86) PCT No.: PCT/KR2007/004431

§ 371 Date: Mar. 13, 2009

(30) Foreign Application Priority Data
Sep. 14, 2006 (KR) 10-2006-0089273

(51) Int. Cl. H04L 1/08; G06F 11/14

(52) U.S. Cl. 714/748; 714/E11.131

(57) ABSTRACT

Provided is a method for preventing consecutive packet errors in a transmitter by combining a hybrid automatic repeat request (HARQ) type II with a selective automatic repeat request (ARQ), including: transmitting a data packet from the transmitter to a receiver; when a negative acknowledgement (NACK) packet corresponding to the data packet is received from the receiver, checking stored information in the NACK packet wherein the stored information represent whether or not the data packet is stored in a buffer; when the data packet is stored in the buffer, transmitting a packet having parity bits to the receiver and storing the data packet in a retransmission queue; and when the data packet is not stored in the buffer, re-transmitting the data packet and maintaining the data packet stored in a transmission queue.

### TECHNICAL FIELD

The present invention relates to a method for preventing successive packet errors in a selective hybrid automatic repeat request (ARQ) system; and, more particularly, to a method for preventing consecutive packet errors caused due to a buffer capacity of a receiver that can prevent wasteful use of bandwidth and consecutive packet errors by re-transmitting a packet is not stored in a buffer of the receiver since errors greater than a buffer capacity of the receiver occur in a selective hybrid ARQ (HARQ) system for correcting packet errors by integrating an HARQ Type II and a selective ARQ and having a long round trip time. The consecutive packet errors occur because a transmitting part re-transmits a packet including parity bits as many as the maximum number of ARQ re-transmission, even though data cannot be restored from the packet formed of parity-bits.

This work was supported by the Information Technology (IT) research and development program of the Korean Ministry of Information and Communication (MIC) and the Korean Institute for Information Technology Advancement (IITA) [2005-S-014-02, “Development of satellite IMT-2000+ technology”].

### BACKGROUND ART

A satellite communication system having a long round trip time is described as an example in the present invention, but the scope of the preset invention is not limited.

Generally, a hybrid automatic repeat request (HARQ) corrects packet errors by combining a forward error correction (FEC) and an automatic repeat request (ARQ).

Herein, the FEC corrects errors occurring in a wireless channel based on an error correction code so that a receiving part can receive accurate information. Also, the ARQ requests a transmitting part to re-transmits a packet when errors occur in the wireless channel so that the receiving part can receive the re-transmitted packet. The ARQ includes a selective ARQ.

In short, the HARQ prevents the errors based on the error correction code and re-transmits the packet based on the ARQ when the errors cannot be corrected based on the error correction code.

There are three types of the HARQ. According to a HARQ Type I scheme, first, the same packet is re-transmitted to the receiving part when the errors of the wireless channel cannot be corrected based on the error correction code.

Second, according to a HARQ Type II scheme, a packet including parity bits of the error correction code is re-transmitted to the receiving part when the errors of the wireless channel cannot be corrected based on the error correction code, instead of re-transmitting the same packet, which is the HARQ Type I scheme. This is called an incremental redundancy (IR) method. In the IR method, a correction capacity of the error correction code is increased by re-transmitting only parity bits and an error occurrence probability during re-transmission becomes low.

Third, in a HARQ Type III, data bits, a first parity bit and another parity bit are re-transmitted together to the receiving part when the errors of the wireless channel cannot be corrected based on the error correction code.

When HARQ Type II scheme is used and data is severely damaged in the initial transmission, the errors are difficult to be corrected based on the parity bit. However, the HARQ Type III scheme can correct errors even when data of the initial packet is severely damaged by transmitting data and parity bits during the re-transmission.

Also, since the HARQ Type III scheme transmits initially transmitted parity bit and another parity bit differently from the HARQ Type I scheme, the receiving part improves error correction ability by gathering the received parity bits. However, the HARQ Type II scheme is most efficient in improving the error correction ability through the re-transmission among the three HARQ types.

Above HARQ methods are adopted in most mobile communication systems since the 3^{rd} Generation (3G). Specifically, the IR method of the HARQ Type II scheme is dominant. However, the HARQ Type II scheme and the HARQ Type III scheme require a receiving buffer in the receiving part, which is different from the ARQ method and the HARQ Type I scheme.

That is, the ARQ method and the HARQ Type I scheme request re-transmission of the packet to the transmitting part when errors occur in the wireless channel and throw received error packet. However, the HARQ Type II scheme and the HARQ Type III scheme store the received error packet and decode by integrating the received error packet and the re-transmission packet so that the receiving buffer having sufficient capacity is needed in the receiving part. Particularly, when the selective ARQ method of the ARQ methods is used, the receiving buffer should have a capacity as large as a volume obtained by multiplying the maximum number of packets that can be transmitted during a round trip time by the maximum number of re-transmission.

As the size of the receiving buffer is increased, complexity of a physical layer is increased. Therefore, most of the recent mobile communication systems following the 3G systems integrate the HARQ method with a stop and wait (SAW) ARQ method.

However, when the SAW ARQ method is used, transmission rate is limited whereas the size of the receiving buffer and the complexity are decreased. Thus, an N-channel SAW ARQ method is used to complement the disadvantages of the SAW ARQ method. The N-channel SAW ARQ method can have throughput N times higher than the SAW ARQ by applying ARQ in N channels.

Meanwhile, a satellite data service system having the HARQ method has a long round trip time. Particularly, a geostationary orbit satellite has a longer round trip time than that of the satellite data service system. Therefore, even the N-channel SAW ARQ method cannot stop the wasteful use of bandwidth.

Finally, the selective ARQ method and the HARQ methods, i.e., HARQ Type II and HARQ Type III, should be used to improve the bandwidth efficiency. However, when errors occur more than the receiving buffer can accommodate, in other worlds, when the received error packet is not stored in the receiving part, consecutive packet error occurs because the transmitting part re-transmits packets including parity bits as many times as the maximum number of re-transmission. This calls for development of methods capable of preventing the consecutive packet errors.

### DISCLOSURE

### Technical Problem

It is, therefore, an object of the present invention to providing a method for preventing consecutive packet errors caused due to a buffer capacity of a receiver that can prevent wasteful use of bandwidth and consecutive packet errors by checking that a data packet stored in a buffer of the receiver based on stored 1-bit information of a NACK packet transmitted from the receiver and re-transmitting the data packet in a selective HARQ system for correcting packet errors by integrating a hybrid automatic repeat request (HARQ) Type II with a selective ARQ and having a long round trip time. The consecutive packet errors occur because a transmitting part re-transmits a packet including parity bits as many times as the maximum number ARQ re-transmission, even though data cannot be restored based on the packet including parity bits.

It is, therefore, another object of the present invention to providing a method for preventing consecutive packet errors caused due to a buffer capacity of a receiver that can prevent wasteful use of bandwidth and consecutive packet errors by estimating a buffer capacity based on an initial buffer capacity of the receiver and feedback ACK/NACK packets transmitted from the receiver, checking that a transmission data packet is not stored in a buffer of the receiver and re-transmitting the data packet in a selective HARQ system capable of correcting packet errors by integrating a hybrid automatic repeat request (HARQ) Type II with a selective ARQ and having a long round trip time. The consecutive packet error occurs because a transmitting part re-transmits a packet including parity bits as many as the maximum number of ARQ re-transmission, even though data cannot be restored based on the packet including parity-bits.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with one aspect of the present invention, there is provided a method for preventing consecutive packet errors in a transmitter by combining a hybrid automatic repeat request (HARQ) type II with a selective automatic repeat request (ARQ), including: transmitting a data packet from the transmitter to a receiver; when a negative acknowledgement (NACK) packet corresponding to the data packet is received from the receiver, checking stored information in the NACK packet wherein the stored information represent whether or not the data packet is stored in a buffer; when the data packet is stored in the buffer, transmitting a packet having parity bits to the receiver and storing the data packet in a re-transmission queue; and when the data packet is not stored in the buffer, re-transmitting the data packet and maintaining the data packet stored in a transmission queue.

In accordance with another aspect of the present invention, there is provided a method for preventing consecutive packet errors in a receiver by combining a HARQ type II with a selective ARQ, including: when the receiver receives a data packet from a transmitter, checking whether the data packet is normal or not; if the data packet is normal, transmitting an ACK packet to the transmitter; and if the data packet is abnormal, inserting a stored information representing whether the data packet is stored in a buffer or not into a NACK packet and transmitting the NACK packet to the transmitter.

In accordance with another aspect of the present invention, there is provided a method for preventing consecutive packet errors in a transmitter by combining a HARQ type II with a selective ARQ, including: a) storing an initial buffer capacity of a receiver; b) transmitting a data packet to a receiver; c) receiving an ACK packet or a NACK packet corresponding to the data packet from the receiver; d) estimating the buffer capacity of the receiver based on the initial buffer capacity and the ACK/NACK packet; e) when the total size of the data packet is larger than residual capacity of the buffer, re-transmitting the data packet and maintaining the data packet in a transmission queue; and f) when the total size of the data packet is not greater than the residual capacity of the buffer, transmitting a packet having parity bits and storing the data packet in a re-transmission queue.

### Advantageous Effects

The present invention can prevent wasteful use of bandwidth and consecutive packet errors by checking whether a data packet is stored in a buffer of a receiver or not based on stored 1-bit information of a NACK packet received from the receiver and re-transmitting the data packet in a selective HARQ system for correcting packet errors by integrating a hybrid automatic repeat request (HARQ) Type II with a selective ARQ and having a long round trip time. The consecutive packet errors occur because a transmitting part re-transmits a packet including parity bits as many times as the maximum number of ARQ re-transmission, even though data cannot be restored based on the packet including parity bits.

Also, the method of the present invention can have a small buffer in a receiver and as much throughput as a case where the buffer of the receiver is sufficiently big by combining the HARQ Type II with the selective ARQ in a system having a long round trip time.

### DESCRIPTION OF DRAWINGS

FIG. 1 is a diagram illustrating a data transmission/reception route of a satellite communication system to which the present invention is applied.

FIG. 2 is a diagram illustrating a queue of a transmitter in the satellite communication system to which the present invention is applied.

FIG. 3 is a diagram illustrating a NACK packet in accordance with the present invention.

FIG. 4 is a flowchart describing a method for preventing consecutive packet errors caused by a buffer capacity of a receiver in a selective hybrid automatic repeat request (HARQ) system in accordance with a first embodiment of the present invention.

FIG. 5 is a flowchart describing a method for preventing consecutive packet errors caused by a buffer capacity of a receiver in the selective HARQ system in accordance with a second embodiment of the present invention.

FIG. 6 is a graph showing a performance of the selective hybrid ARQ system in accordance with the present invention.

### BEST MODE FOR THE INVENTION

Other objects and aspects of the invention will become apparent from the following description of the embodiments with reference to the accompanying drawings, which is set forth hereinafter. Also, when it is considered that detailed description on a related art may obscure the points of the present invention unnecessarily in describing the present invention, the description will not be provided herein. Hereinafter, specific embodiments of the present invention will be described with reference to the accompanying drawings. In the present invention, a satellite system is described as an embodiment, but the present invention can be applied to a terrestrial mobile communication system forming a cell centered on a base station.

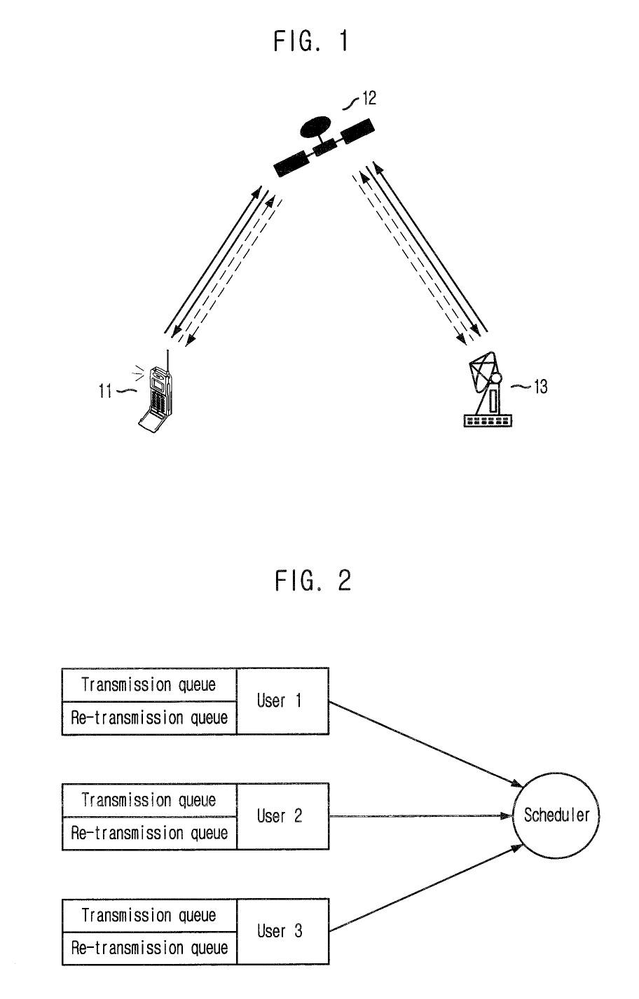

FIG. 1 is a diagram illustrating a data transmission/reception route of a satellite communication system to which the present invention is applied.

When communication service is provided, there are two cases that a satellite can function as a repeater and that it functions as a circuit switch.

The data transmission/reception route is presented as dotted line when the satellite functions as a circuit switch, i.e., an on-board processing (OBP) method, and the data transmission/reception route is presented as solid line when the satellite performs the functions of a repeater.

In case of a geostationary orbit satellite, generally it takes 0.125 second for transmitting a signal from a terminal 11 to the satellite 12 and another 0.125 second from the satellite 12 to a terrestrial control system 13. Therefore, a round trip time of the OBP method is 0.25 second, but the round trip time of the repeater is 0.5 second because the signal has to make a round trip to the terrestrial control system 13 from the terminal 11 through the satellite 12. The round trip time of the repeater is larger than that of a terrestrial mobile communication system.

Generally, when the HARQ method and the selective ARQ method are used together, a buffer capacity of the receiver is required as expressed the following Eq. 1. Therefore, the satellite system requires a larger receiving buffer than the terrestrial mobile communication system, and a complexity of a physical layer is increased.

buffer capacity=round trip time×size of packet×maximum number of re-transmission Eq. 1

FIG. 2 is a diagram illustrating a queue of a transmitter in the satellite communication system to which the present invention is applied.

As shown in FIG. 2, a user queue is divided into a transmission queue and a re-transmission queue and managed. By managing the user queue in this way, operations of the user queue according to an initial transmission packet and a re-transmission packet can be performed differently. In addition, it is possible to record information in such a manner that whether packet is an initial transmission packet or re-transmission packet while maintaining one queue.

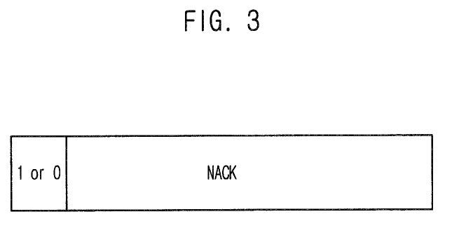

FIG. 3 is a diagram illustrating a NACK packet in accordance with the present invention.

As shown, the NACK packet includes 1-bit information notifying that received error packet is not stored due to error packets going over the buffer capacity of the receiver.

Generally, the NACK packet includes packet number and other various control information. A general packet includes a reserved-bit which can be applied to various methods. Therefore, error packets occurring over a buffer capacity of the receiver can be noticed to the transmitter, which is a central station by using the reserved-bit without modification a conventional system not a new system.

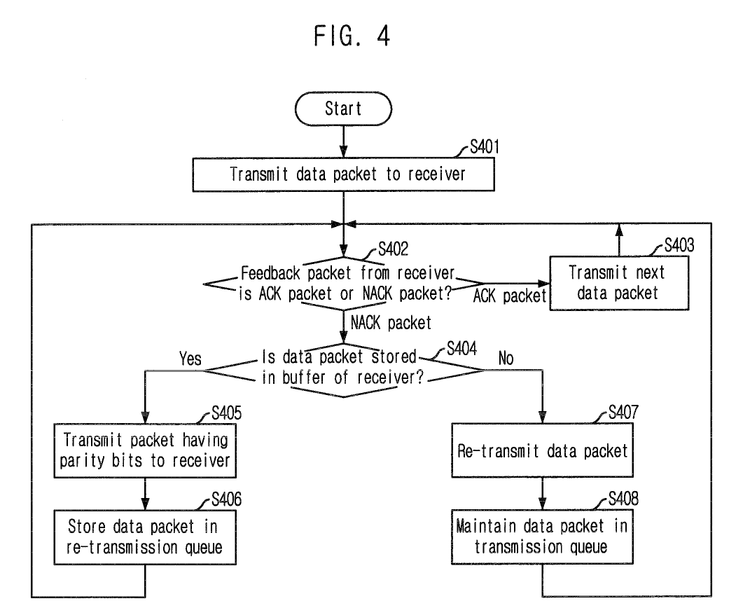

FIG. 4 is a flowchart describing a method for preventing consecutive packet errors caused by a buffer capacity of a receiver in a selective HARQ system in accordance with a first embodiment of the present invention.

First, a central station transmits a data packet to a receiver at step S401.

The transmitter receives a feedback packet from the receiver corresponding to the data packet, and checks whether the feedback packet is an acknowledgement (ACK) packet or a negative acknowledgement (NACK) packet at step S402.

Here, when the receiver receives the data packet, the receiver checks whether the data packet is normal or not. If the data packet is normal, the receiver transmits the ACK packet to the transmitter. Also, if the data packet is not normal, the receiver transmits the NACK packet to the transmitter. Here, 1-bit information notifying whether the received data packet is stored in the buffer or not is inserted into the NACK packet and transmitted to the transmitter. For example, when the received data packet is stored in the buffer because the buffer capacity is sufficient, the 1-bit information of the NACK packet is recoded as “0”. Also, when the received data packet is not stored in the buffer because the buffer capacity is not enough, the 1-bit information of the NACK packet is recoded as “1”.

At step S403, if the feedback packet is the ACK packet, the transmitter transmits the next data packet to the receiver and goes to the step S402. Here, if there are packets to be transmitted in the re-transmission queue, packets in the transmission queue is transmitted after the packets in the re-transmission queue are all transmitted. A priority of transmission described above can be changed according to implementation methods.

If the feedback packet is the NACK packet, the transmitter checks whether the data packet is stored in the buffer or not based on the 1-bit information at step S404.

If the data packet is stored in the buffer at step S404, packet having parity bits is transmitted to the receiver at step S405. Here, it is desirable that transmission of the packet is performed by selection of a scheduler.

Then, the transmitted data packet is stored in the re-transmission queue and the logic flow goes to the step S402 at step S406. Here, if the data packet is stored in the re-transmission queue, do not store. In addition, if the system uses one queue, information notifying that whether re-transmission is performed or not is recorded.

If the data packet is not stored in the buffer at step S404, the data packet is re-transmitted at step S407. Here, it is desirable that re-transmission of the packet is performed by selection of the scheduler.

Then, the data packet stored in the transmission queue is maintained and goes to the step S402 at step S408.

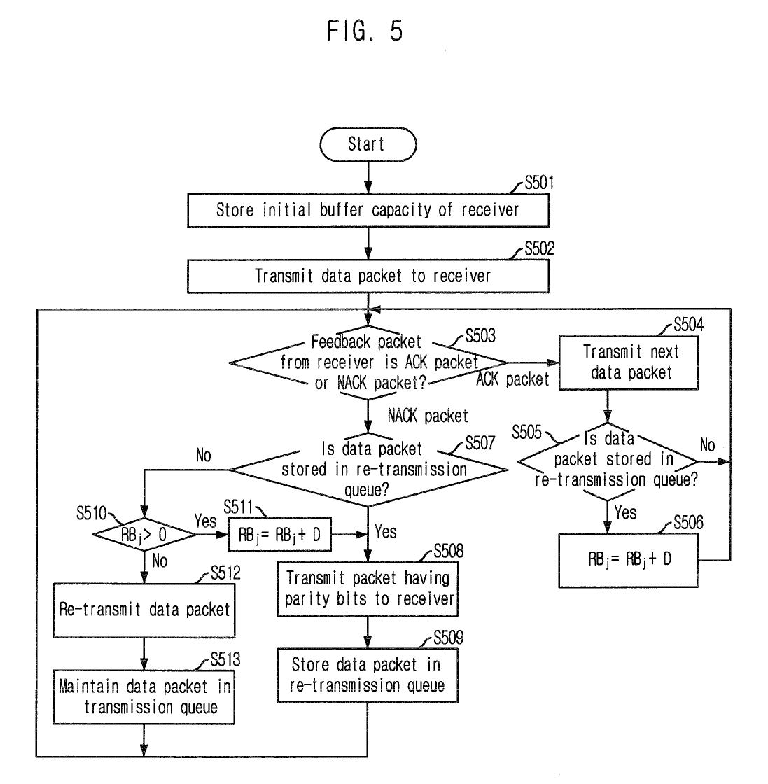

FIG. 5 is a flowchart describing a method for preventing consecutive packet errors caused by a buffer capacity of a receiver in the selective HARQ system in accordance with a second embodiment of the present invention.

First, the central station stores an initial buffer capacity of the receiver at step S501. Here, it is desirable that the initial buffer capacity of the receiver is provided from the receiver.

Then, the transmitter transmits a data packet to the receiver at step S502.

Then, the transmitter receives a feedback packet from the receiver in response to the data packet, and checks whether the feedback packet is an ACK packet or a NACK packet at step S503.

Here, when the receiver receives the data packet, the receiver checks whether the data packet is normal or not. If the data packet is normal, the receiver transmits the ACK packet to the transmitter. Also, if the data packet is not normal, the receiver transmits the NACK packet to the transmitter.

If the feedback packet is the ACK packet at step S503, the transmitter transmits the next data packet to the receiver at step S504. Here, if there are packets to be transmitted in the re-transmission queue, packets in the transmission queue is transmitted after the packets in the re-transmission queue are transmitted. A priority of transmission described above can be changed according to implementation methods.

Next, the transmitter checks whether the data packet is stored in the re-transmission queue or not at step S505. If the data packet is stored in the re-transmission queue, residual capacity of the buffer in the receiver is increased as much as the size of the data packet, i.e., RBⱼ=RBⱼ+D, and then the logic flow goes to the step S503 at step S506. Also, if the data packet is not stored in the re-transmission queue, goes to the step S503. Here, RBⱼ is the value for estimating the size of the receiving buffer, i.e., residual capacity of the receiving buffer; and D is the size of the data packet.

If the feedback packet is the NACK packet at step S503, the transmitter checks that whether the data packet is stored in the re-transmission queue or not at step S507.

If the data packet is stored in the re-transmission queue at step S507, a parity-bit packet which including parity bits is transmitted to the receiver at step S508. Here, it is desirable that transmission of the packet is performed by selection of a scheduler.

Then, the transmitted data packet is stored in the re-transmission queue and the logic flow goes to the step S503 at step S509. Here, if the data packet is stored in the re-transmission queue, do not store. In addition, if the system uses one queue, information notifying that whether re-transmission is performed or not is recorded.

If the data packet is not stored in the re-transmission queue at step S507, the transmitter checks that estimated capacity of the receiving buffer is full or not, i.e., RBⱼ>0, at step S510.

If the estimated capacity of the receiving buffer is left, the transmitter subtracts the size of the data packet from the estimated capacity, i.e., RBⱼ=RBⱼ−D, and then the logic flow goes to the step S508 at step S511.

If the estimated capacity of the receiving buffer is not left, the data packet is re-transmitted at step S512. Here, it is desirable that re-transmission of the packet is performed by selection of the scheduler.

Then, the data packet stored in the transmission queue is maintained and goes to the step S503 at step S513.

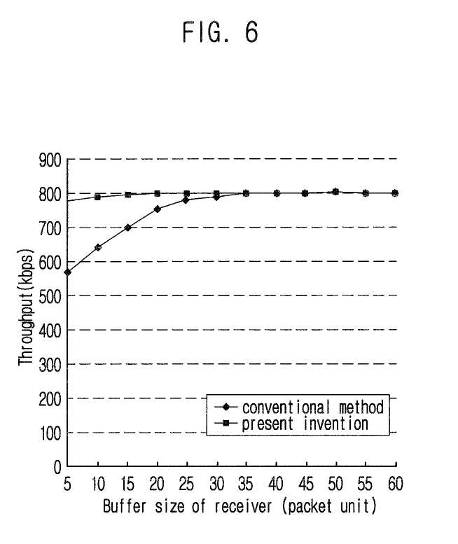

FIG. 6 is a graph showing a performance of the selective hybrid ARQ system in accordance with the present invention. It shows simulation result presenting the performances when the present invention is applied and when the present invention is not applied.

As shown in FIG. 6, this test uses an adaptive transmission method by using 5 receivers and a proportional fairness scheduler.

The graph represents the sum of throughput for received data from the five receivers according to the size of the receiving buffer. In the present invention, reasonable throughput is acquired when the buffer is small, but in the conventional method, reasonable throughput is presented when the size of the buffer have to be large.

Through results of this test, it is verified that the present invention can obtain reasonable throughput with the small size of the receiving buffer and reducing complexity of the receiver.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 2006-0089273, filed with the Korean Intellectual Property Office on Sep. 14, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for preventing consecutive packet errors in a transmitter, comprising:
transmitting a data packet from the transmitter to a receiver;
when a negative acknowledgement (NACK) packet corresponding to the data packet is received from the receiver, checking stored information in the NACK packet wherein the stored information represent whether or not the data packet is stored in a buffer;
when the data packet is stored in the buffer, transmitting a packet having parity bits to the receiver and storing the data packet in a re-transmission queue; and
when the data packet is not stored in the buffer, re-transmitting the data packet and maintaining the data packet stored in a transmission queue.

2. The method as recited in claim 1, wherein the stored information is represented by using 1-bit information in the NACK packet.

3. A method for preventing consecutive packet errors in a receiver, comprising:
when the receiver receives a data packet from a transmitter, checking whether the data packet is normal or not;
if the data packet is normal, transmitting an acknowledgement (ACK) packet to the transmitter; and
if the data packet is abnormal, inserting a stored information representing whether the data packet is stored in a buffer or not into a negative acknowledgement (NACK) packet and transmitting the NACK packet to the transmitter.

4. The method as recited in claim 3, wherein the stored information is represented by using 1-bit information in the NACK packet.

5. A method for preventing consecutive packet errors in a, comprising:
storing an initial buffer capacity of a receiver;
transmitting a data packet to a receiver;
receiving an acknowledgement (ACK) packet or a negative acknowledgement (NACK) packet corresponding to the data packet from the receiver;
estimating the buffer capacity of the receiver based on the initial buffer capacity and the ACK/NACK packet;
when the total size of the data packet is larger than residual capacity of the buffer, re-transmitting the data packet and maintaining the data packet in a transmission queue; and
when the total size of the data packet is not greater than the residual capacity of the buffer, transmitting a packet having parity bits and storing the data packet in a re-transmission queue.

6. The method as recited in claim 5, wherein the estimating the buffer capacity of the receiver based on the initial buffer capacity and the ACK/NACK packet includes:
if the feedback packet is the ACK packet, transmitting a next data packet and increasing the residual capacity of the buffer as the size of the data packet when the data packet is stored in the re-transmission queue;
if the feedback packet is the NACK packet, checking whether the data packet is stored in the re-transmission queue; and
when the data packet is not stored in the re-transmission queue and the estimated buffer capacity is not full, reducing the residual capacity of the buffer as much as the size of the data packet.
